(19) United States
(12) Patent Application Publication
(10) Pub. No.: US 2017/0000668 A1
(43) Pub. Date: Jan. 5, 2017

(54) REFORMABLE POSITIONING DEVICE

(71) Applicant: KONINKLIJKE PHILIPS N.V., Eindhoven (NL)

(72) Inventors: Vanessa SATTELE, EINDHOVEN (NL); Jacco Christof EERDEN, EINDHOVEN (NL); Tom Philippe Jean Jacques DELAEY, MOL (BE); Eckhardt Henricus Matheus SCHRAVEN, ROSMALEN (NL); Marjolein Irene VAN LIESHOUT, WAALRE (NL); Anthonius Petrus Gerardus Emanuel JANSSEN, BERGHEM (NL); Eefje Janet ARTS-HORNIX, NUENEN (NL)

(21) Appl. No.: 15/102,549

(22) PCT Filed: Dec. 3, 2014
(86) PCT No.: PCT/IB2014/066543

§ 371 Date: Jun. 8, 2016

Related U.S. Application Data
(60) Provisional application No. 61/914,984, filed on Dec. 12, 2013.

(51) Int. Cl. A61G 7/002; A61G 7/015; A61G 7/05; A47D 13/08

(52) U.S. Cl. CPC A61G 7/002; A47D 13/08; A61G 7/015; A61G 7/0525

(57) ABSTRACT

A reformable positioning device providing a user-configurable structure to facilitate customized support and positioning of a subject. The device may comprise a support structure including a support surface having dimensions to accommodate the subject. The support structure may include a resiliently deformable body configured to hold a user-configured shape to position the subject. The resiliently deformable body may be enclosed within and/or otherwise covered by a cover.

### BACKGROUND

1. Field

The present disclosure pertains to devices and methods for positioning a subject on a support surface.

2. Description of the Related Art

Positioning a subject, such as a medical patient, in the proper position is often desirable for the benefit of the subject in that it promotes comfort, health and healing. Hospital beds may be outfitted with mechanisms to adjust the position of the subject to either lying or sitting, however may be limited in providing customized positioning support based on individual subject needs.

### SUMMARY

Accordingly, one or more aspects of the present disclosure relate to a reformable positioning device for positioning a subject. The reformable positioning device comprises a support structure. The support structure comprises a material constructed and arranged to be selectively deformably reshaped and to retain its deformed shape. The support structure is configured to retain the deformed shape in accordance with a desired configuration that provides desired positioning of the subject. The support structure includes multiple user-configurable support regions for forming the desired shape for positioning the subject. The support structure includes a support surface having dimensions to accommodate the entire body of the subject.

Another aspect of the present disclosure relates to a method of providing a reformable positioning device for positioning a subject. The method comprises the operations of providing a support structure comprising a material constructed and arranged to be selectively deformably reshaped and to retain its deformed shape, and/or other operations. The support structure is configured to retain the deformed shape in accordance with a desired configuration that provides desired positioning of the subject. The support structure includes multiple user-configurable support regions for forming the desired shape for positioning the subject. The support structure includes a support surface having dimensions to accommodate the entire body of the subject.

Still another aspect of present disclosure relates to a reformable positioning device for positioning a subject. The reformable positioning device comprises a supporting means. The supporting means comprises a material constructed and arranged to be selectively deformably reshaped and to retain its deformed shape. The supporting means is configured to retain the deformed shape in accordance with a desired configuration that provides desired positioning of the subject. The supporting means includes multiple user-configurable support regions for forming the desired shape for positioning the subject. The supporting includes supporting surface means having dimensions to accommodate the entire body of the subject.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 depicts a top view of an embodiment of the reformable positioning device including a support structure having a resiliently deformable body configured to hold a user-configured shape to support a subject;

FIG. 2 depicts a side view of the device of FIG. 1;

FIG. 3 is a cross sectional view of the device of FIG. 1 as seen from line AA of FIG. 1;

FIG. 4 depicts a perspective view of the device of FIG. 1 holding a shape for supporting an infant subject;

FIG. 5 depicts a top view of another embodiment of the reformable positioning device having a resiliently deformable body comprising multiple articulable members;

FIG. 6 depicts a cross sectional view of the device of FIG. 1 as seen from line BB of FIG. 5;

FIG. 7 depicts a cross sectional view of the device of FIG. 1 depicting one of the articulable members holding a position to support a subject;

FIG. 8 shows a top view of an embodiment of a resiliently deformable body comprising multiple cushion members vacuum sealed within a pliable container;

FIG. 8a shows another embodiment a resiliently deformable body comprising multiple cushion members vacuum sealed within a pliable container formed with multiple vacuum sealed portions;

FIG. 9 depicts cross sectional view of the resiliently deformable body of FIG. 8 as seen from line CC of FIG. 8;

FIG. 10 shows a top view of still another embodiment of a resiliently deformable body comprising multiple flexible pop-out sections;

FIG. 11 shows a cross sectional view of the resiliently deformable body of FIG. 10 in a first configuration, as seen from line DD of FIG. 10;

FIG. 12 shows a cross sectional view the resiliently deformable body of FIG. 10 in a second configuration, as seen from line DD of FIG. 10;

FIG. 13 depicts a top view of yet another embodiment of a resiliently deformable body comprising a frame and multiple cross members configured to hold a user-configured shape;

FIG. 14 shows a detailed view of one of the cross members of the resiliently deformable body of FIG. 13;

FIG. 15 shows a detailed view of the cross member of FIG. 14, with the cross member in an upwardly bowed position;

FIG. 16 depicts an example of the resiliently deformable body of FIG. 13 holding a shape to support a subject;

FIG. 17 shows a top view of yet another embodiment of the reformable positioning device comprising shape memory components;

FIG. 18 shows a perspective view of the reformable positioning device of FIG. 17 depicting the support structure holding a shape for positioning a subject;

FIG. 19 shows a view of another embodiment of the reformable positioning device comprising the support structure and a base component used for repositioning and supporting the support structure without disturbing the shape of the reformable positioning device;

FIG. 20 shows an end view of the support structure and base component of FIG. 19, showing the support structure in a first supported position;

FIG. 21 shows another end view of the support structure and base component of FIG. 19, showing the support structure in a second supported position;

FIG. 22 shows a view of still another embodiment of the reformable positioning device comprising the support structure and a base component;

FIG. 23 shows a view of another embodiment of the reformable positioning device comprising the support structure having repositioning components integrated into the support structure;

FIG. 24 shows another depictions of the embodiment of the reformable positioning device of FIG. 23 in a first position;

FIG. 25 shows an end view of the embodiment of the reformable positioning device of FIG. 23 in the first position as shown in FIG. 24;

FIG. 26 shows another end view depiction of the embodiment of the reformable positioning device shown in FIG. 23 in a second position;

FIG. 27 shows a top view of another embodiment of reformable positioning device comprising support structure including a cover and a resiliently deformable body which runs the periphery of the cover;

FIG. 28 shows a view of the resiliently deformable body used in the embodiment of the reformable positioning device shown in FIG. 27;

FIG. 29 depicts a top view of yet another embodiment of a resiliently deformable body comprising multiple articulable sections and arm;

FIG. 30 shows a perspective view of the embodiment of the resiliently deformable body shown in FIG. 29; and

FIG. 31 depicts a method of providing a reformable positioning device.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

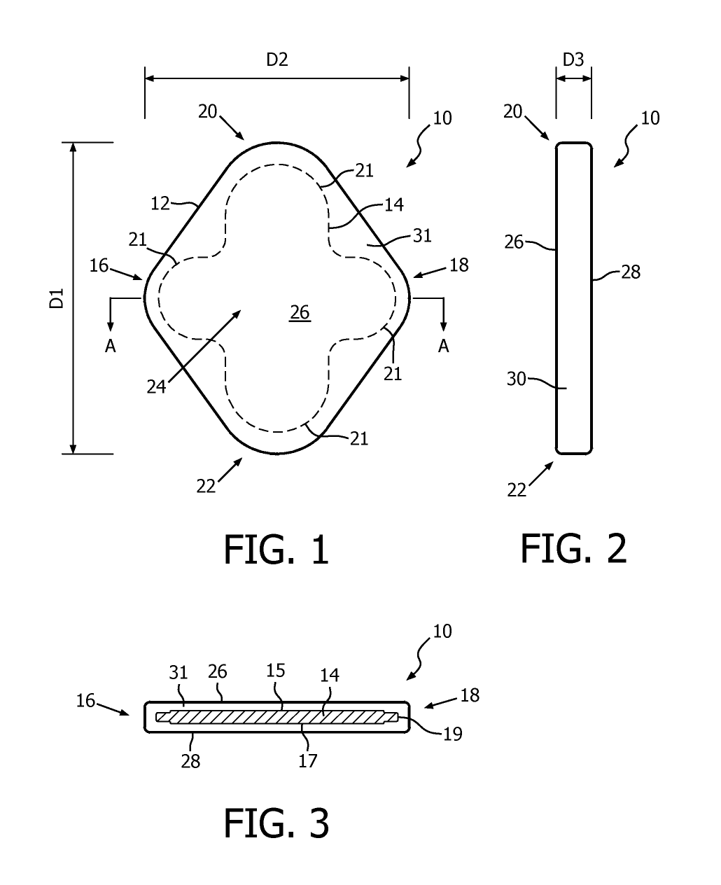

FIG. 1, FIG. 2, and FIG. 3 depict views of an exemplary embodiment of the reformable positioning device 10 providing a user-configurable structure to facilitate customized support and positioning of a subject. Reformable positioning device 10 may comprise a support structure 12. Support structure 12 may comprise a material constructed and arranged to be selectively deformably reshaped and to retain its deformed shape. Support structure 12 may be configured to retain the deformed shape in accordance with a desired configuration that provides desired positioning of the subject. Support structure 12 may comprise a resiliently deformable body 14 constructed and arranged to be selectively deformable and to retain its deformed shape to position the subject (shown in dashed lines in FIG. 1). Exemplary embodiments of resiliently deformable body 14 will be described in more detail herein.

Support structure 12 may include a cover 31. Resiliently deformable body 14 may be enclosed within and/or otherwise covered by cover 31 (see FIG. 3). Cover 31 may be a pad or padding and/or other covering formed from material suitable to provide comfortable layer of support over resiliently deformable body 14. For example cover 31 may be memory form, padding, fabric, or the like.

In some embodiments it is envisioned that support structure 12 may solely comprise resiliently deformable body 14. For example resiliently deformable body 14 may be formed of material suitable to retain a user-configured shape as well as provide padded support layer. In such embodiments a cover, such as cover 31, may be omitted. In some embodiments, those skilled in the art will appreciate that reformable positioning device 10 may be integrally incorporated into existing support platforms. For example, reformable positioning device 10 may be integrally incorporated to comprise some or all of a cradle, a bed, a crib, an incubator, a pad, an operating table, a gurney, a changing table, and/or other platform.

Support structure 12 may include a first surface 26 providing a support surface, second surface 28 opposite first surface 26, and peripheral side edge 30 communicating between first surface 26 and second surface 28. In some embodiments, first surface 26, second surface 28 and peripheral side edge 30 may comprise surfaces of cover 31. In some embodiments, first surface 26, second surface 28 and peripheral side edge 30 may comprise surfaces of resiliently deformable body 14 (e.g., embodiments with cover 31 omitted). Support structure 12, and in particular first surface 26, preferably has dimensions to accommodate the entire body of a subject in a lying, sitting, or otherwise supported position thereon. For example, in some embodiments, reformable positioning device 10 may be used for positioning an infant to lay on their back such that first surface 26 has dimensions to accommodate an infant. In other embodiments, reformable positioning device 10 may be used to position a child, adolescent, young adult, adult, or elderly person such that first surface 26 has dimensions to accommodate the same. Those skilled in the art will readily recognize that the various features of reformable positioning device 10 can simply be scaled to accommodate the various subjects accordingly, and is anticipated. Descriptions of preferred dimensions of support structure 12 and first surface 26 are provided in more detail herein.

Resiliently deformable body 14 may comprise first surface 15, second surface 17 opposite first surface 15, and peripheral side edge 19 communicating between first surface 15 and second side surface 17. Peripheral side edge 19 may define a thickness of resiliently deformable body 14. In embodiments where cover 31 is omitted, first surface 15 may provide the subject support surface.

In some embodiments, resiliently deformable body 14 may be of a shape or may have dimensions which are the same or similar to the shape and/or dimensions of cover 31, when forming support structure 12. For example, first surface 15 of resiliently deformable body 14 may be the same or similar shape and/or may have the same or similar dimensions as first surface 26 of support structure 12.

In some embodiments, such as shown in FIG. 1, resiliently deformable body 14 may be of a shape or have dimensions which are different than that of cover 31. For example, cover 31 may be substantially diamond shaped as shown. Resiliently deformable body 14 may be substantially “cross” shaped and enclosed within cover 31, such that cover 31 defines the overall shape and dimensions for reformable positioning device 10. For example, resiliently deformable body 14 may have four legs 21 forming the cross shape. The cross shape of resiliently deformable body 14 may be preferred for reasons which may become more apparent upon further description of the embodiments of this disclosure presented herein. However, other shapes and/or dimensions for cover 31 and/or resiliently deformable body 14 suitable for the purposes described herein may be employed and are anticipated.

Resiliently deformable body 14 may be formed from materials and/or structures suitable for user-configuration to retain shapes. It may be desired that resiliently deformable body 14 is formed of a material malleable enough to deform by hand by a user, however provide substantial stiffness and resiliency as to hold the desired shape once formed to hold some or all of the weight of the subject positioned thereon. One skilled in the art will understand from this disclosure that for embodiments for use with an infant subject, the malleability to stiffness ratio requirements of resiliently deformable body 14 need not be as stringent when compared to embodiments intended for larger adolescent or adult subjects, mostly due to the weight differences of the subjects as well as the overall size and dimension needs of reformable positioning device 10 for accommodating the entire body of the subject. For example, resiliently deformable body 14 may be formed from a reformable wire-form mesh (e.g., using metal such as a shape memory alloy, or other material), reformable clay, reformable rubber (e.g., flexible silicone or other), self-setting rubber, shape-retaining plastic (e.g., polyethylene homopolymer), shape memory polymer, and/or other suitable material. Additional exemplary embodiments of resiliently deformable body 14 are described herein with reference to remaining figures.

Support structure 12 as described herein comprising resiliently deformable body 14 (with or without cover 31) may include multiple user-configurable support regions to facilitate user-configuration of a desired shape for positioning a subject. For example, a subject may be lying on support structure 12 and it may be desired to position one or more of their legs, neck, head, and/or back, in an elevated or restricted position deemed suitable by a caregiver. Herein a “support region” may refer to a general portion or region of support structure 12 which a user can configure to form and hold a part of the desired shape to support the body of the subject. Individual support regions of support structure 12 may be user-configurable to individually provide support to certain parts of a subject. For example, certain support regions of support structure 12 may be configured generally for support for the left side arm of a subject, right side arm of a subject, legs of the subject, back of the subject, head of the subject, and/or other part of the subject's body. Some or all of the support regions of support structure 12 may correspond (e.g., align or register) to each of legs 21 of resiliently deformable body 14 thereby providing user-configurability and shape-holding functionality of reformable positioning device 10.

As an illustrative example, support structure 12 may include a right side arm support region 16, a left side arm support region 18 opposite the right side arm support region, a head support region 20, a leg support region 22 opposite the head support region 20, and a trunk support region 24 (e.g., back and/or belly support). Right side arm support region 16, left side arm support region 18, head support region 20, and leg support region 22 may each correspond (e.g., align and/or register with) with a leg 21 of resiliently deformable body 14 as shown.

In some embodiments, the dimensions of support structure 12 may be defined by a longitudinal length D1, a lateral length D2, and a thickness D3 (see FIG. 1 and FIG. 2). First surface 26 providing the support surface of reformable positioning device 10 may be defined by longitudinal length D1 and lateral length D2. Longitudinal length D1 may be a distance from head support region 20 of support structure 12 to leg support region 22. Lateral length D2 may be a distance from right side arm support region 16 to left side arm support region 18. In some embodiments, the ratio of longitudinal length D1 to lateral length D2 may be from 1:1 to 2:1, 1:1 to 1:2, and/or other suitable ratio and/or ratio range configured to accommodate the entire body of a subject. For example, in some embodiments longitudinal length D1 may be up to twice as long as lateral length D2, or lateral length D2 may be up to twice as long as longitudinal length D1.

In some embodiments suitable for use with infant subjects, support structure 12 may have dimensions to accommodate an infant such that longitudinal length D1 and lateral length D2 may be from 250-600 mm. For example, Table 1 below shows an example of a sizing chart showing suitable dimensions for reformable positioning device 10 given the size of the infant. The table illustrates embodiments where the ratio of D1 to D2 is approximately 1:1. In some embodiments, thickness D3 may be in the range of 12-150 mm.

TABLE 1
Sizing chart for infants

Device Dimensions (mm)

| Infant Size (grams) | D1 | D2 |
|---|---|---|
| <800 | 300 | 295 |
| 800-1300 | 400 | 390 |
| 1300-2250 | 510 | 500 |
| >2250 | 550 | 540 |

It is noted that Table 1 provided above is for illustrative purposes only, and it anticipated that the dimensions of reformable positioning device 10 may be larger or smaller than those dimensions shown. For example it is anticipated that for larger subjects (e.g., larger babies, adolescents, and adults), the dimensions of reformable positioning device 10 may be suitably scaled to accommodate the subject.

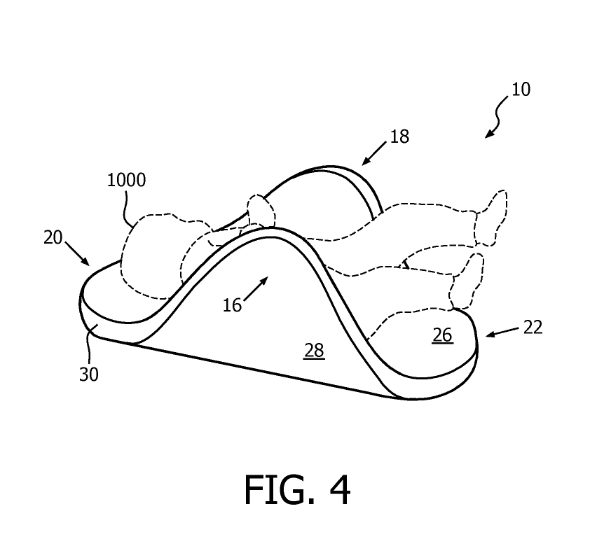

An exemplary embodiment of reformable positioning device 10 providing support to position infant subject 1000 is shown in FIG. 4. It may be desired to position infant subject 1000 on their back (e.g., restrict lateral movement and/or rolling). In some embodiments, infant subject 1000 may be supported on reformable positioning device 10 on the support surface (e.g., first surface 26) such that the infant's head is located at or near head support region 20, infant's legs and feet are located at or near leg support region 22, right arm is located at or near right side arm support region 16, and left arm is located at or near left side arm support region 18. In the example shown, reformable positioning device 10 may be configured to hold a desired shape wherein right side arm support region 16 and left side arm support region 18 are folded, bent, and/or otherwise configured to extend upwardly (e.g., relative first surface 26). Right side arm support region 16 and left side arm support region 18 in this configuration may provide barriers and/or sidewalls on the left and right sides of infant subject 1000 to substantially confine or cradle infant subject 1000 within reformable positioning device 10. This may be desirable to restrict lateral movement for positioning infant subject 1000 on their back.

Although the current depiction shows a relatively simple shape held by reformable positioning device 10, more or less support parts of support structure 12 may be user-manipulated to form other shapes and/or other configurations to provide support for maintaining other subject positions. For example, head support region 20 may be user-configured to hold a shape which supports the infant subject's head and/or neck in an a desired position, leg support region 22 may be user-configured to hold a shape which supports infant subject's feet or legs in a desired position, and/or trunk support region 24 may be user-configured to hold a shape which supports infant subject's back in a desired position. As could be imagined, resiliently deformable body 14 may essentially be formed and reformed by a user into an infinite number of shapes and/or configurations as needed to provide user-configured support for positioning a subject. As such those skilled in the art may appreciate that the descriptions and depictions provided herein are intended merely to portray exemplary embodiments of the various features and function of reformable positioning device 10 and should not be considered limiting.

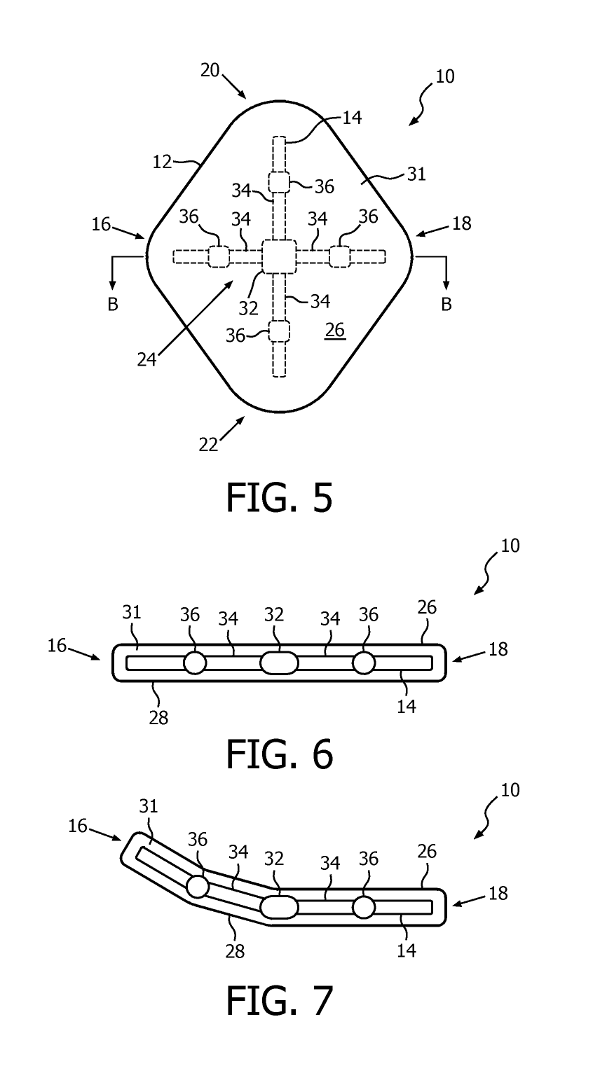

FIG. 5 shows another exemplary embodiment of reformable positioning device 10 comprising resiliently deformable body 14 and cover 31. Resiliently deformable body 14 in the current embodiment may include multiple articulable members 34 extending from central hub 32. For example, cover 31 may be substantially diamond shaped as shown, wherein hub 32 is located within the trunk support region 24 of support structure 12 and wherein each of the articulable members 34 extends from hub 32 to each of the right side arm support region 16, left side arm support region 18, head support region 20, and leg support region 22.

Resiliently deformable body 14 may be configured such that articulable members 34 are rotatable around hub 32. Articulable members 34 may include one or more additional rotatable joints 36 facilitating additional articulation. In some embodiments, articulable members 34 may be formed from plastic (e.g., extruded, and/or molded) or other material. Rotatable joints 36 and the engagement point of articulable members 34 to hub 32 may comprise hinges, pivots, and/or other rotatable engagement. In some embodiments, rotatable joints 36 and the engagement point of articulable members 34 to hub 32 may be formed to include an amount of rotational friction such that articulable members 34 can be individually articulated to form a shape and to retain the shape. In some embodiments, rotatable joints 36 and the engagement points of articulable members 34 to hub 32 may comprise ratchet mechanisms (e.g., using a gear and pawl), spring clutch, spring ball and detent, and/or other mechanisms and/or techniques suitable for the intended purpose of forming and retaining a user-configured shape.

As an illustrative example, FIG. 6 and FIG. 7 shows cross sectional views of the reformable positioning device 10 of FIG. 5 showing resiliently deformable body 14 enclosed within cover 31. FIG. 6 depicts reformable positioning device 10 lying flat. FIG. 7 depicts an example of one of articulable members 34 (e.g., aligned with right side arm support region 16) rotated upward with respect to hub 32 as well as rotated about rotatable joint 36. It is noted that additional articulable members 34 may be user-configured to form any number of shapes of reformable positioning device 10 deemed suitable by the user.

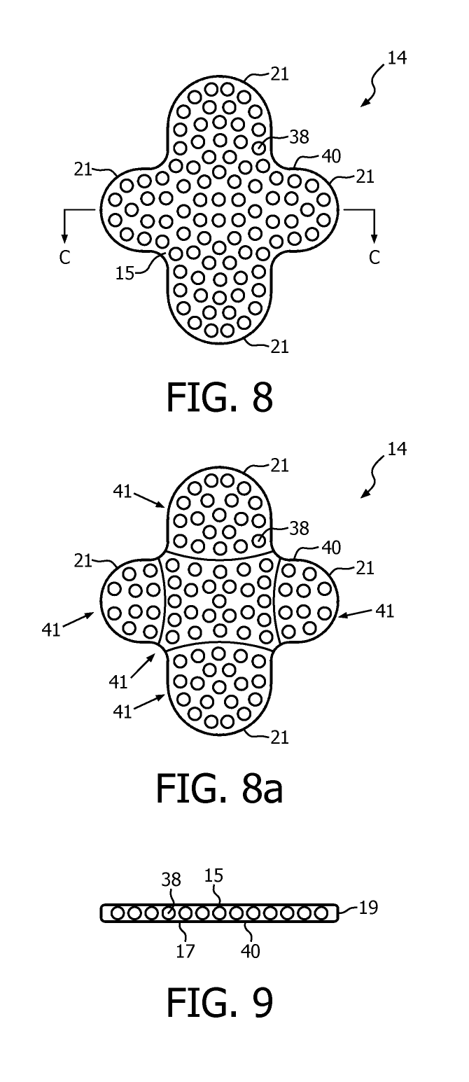

FIG. 8, FIG. 8a, and FIG. 9 show views of another exemplary embodiment of resiliently deformable body 14. Resiliently deformable body 14 may comprise multiple cushion members 38 enclosed within pliable container 40. Cushion members 38 may be spherical or substantially spherical members formed from memory foam, closed cell foam, closed cell foam with an air core, fabric, and/or other material suitable to provide padded support when a subject is supported thereon. In some embodiments, cushion members 38 may be enclosed within pliable container 40 by forming a vacuum within pliable container 40 and sealing pliable container 40 with respect to the ambient environment. For example pliable container 40 may be a type of vacuum packaging. Pliable container 40 may be configured to enclose and seal cushion members 38 therein and facilitate drawing air from the packaging to compress cushion members 38 within pliable container 40 (e.g., the packaging may have a connector on the exterior of the packaging having an orifice in fluid communication with the interior of the packaging, wherein the connector may be configured for attachment to a vacuum pump). This compression of cushion members 38 within pliable container 40 may result in a substantial amount of fiction between adjacent cushion members 38, and/or between cushion members 38 and the walls of pliable container 40. The friction between adjacent cushion members 38 and/or between cushion members 38 and the walls of pliable container 40 may allow resiliently deformable body 14 to form and retain essentially any user-configured shape. For example, each of legs 21 may be user configured to form a desired shape, where the shape is retained at least due to the friction between adjacent cushion members 38 and/or between cushion members 38 and the walls of pliable container 40.

In some embodiments, cushion members 38 may include a friction enhancing exterior surface layer to increase the resulting friction between adjacent cushion members 38 and/or between cushion members 38 and the walls of pliable container 40. For example, cushion members 38 may be formed from a closed cell foam material having a silicone and/or other friction increasing material as an exterior surface layer. This may result in improving the overall shape holding capability of reformable positioning device 10.

The embodiment of resiliently deformable body 14 shown in FIG. 8a depicts cushion members 38 sealed within pliable container 40, wherein pliable container 40 is formed from multiple sections 41. For example each of the sections 41 may be individually vacuum sealed portions of pliable container 41. In some embodiments, individual sections 41 may correspond to an individual leg 21 of resiliently deformable body 14, and in turn may align with each one of right side arm support region 16, left side arm support region 18, head support region 20, and leg support region 22 of support structure 12. Resiliently deformable body 14 may include central section 41 which in turn aligns with trunk support region 24 of support structure 12.

It is noted that resiliently deformable body 14 in the current embodiment may be employed with a cover, such as cover 31 shown previously in FIG. 1 to form support structure 12 as described herein. In other embodiments however, support structure 12 may solely comprise the current embodiment of resiliently deformable body 14 wherein cushion members 38 may provide the suitable padding for the subject without the use of a cover.

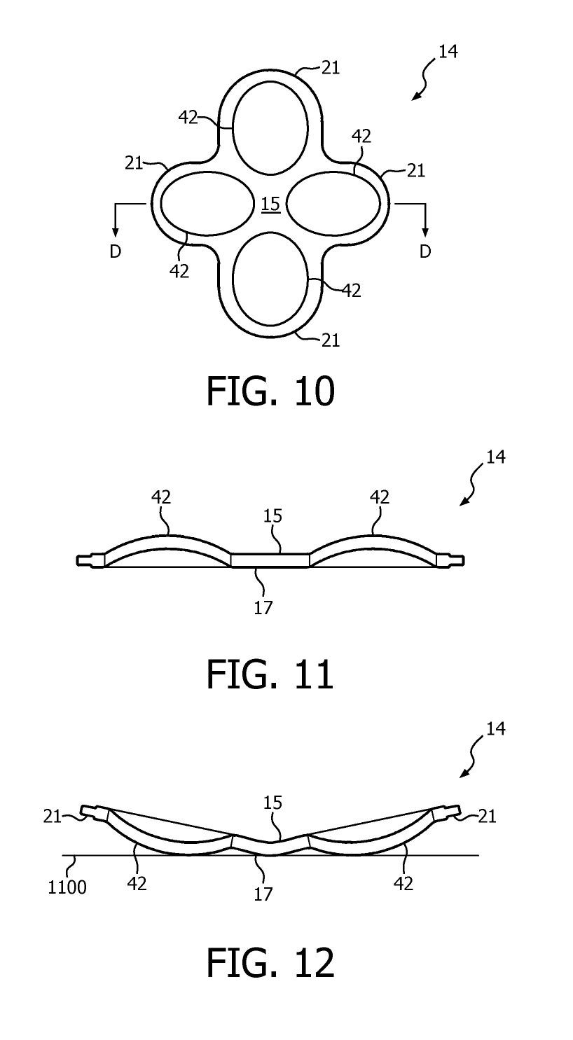

FIG. 10, FIG. 11, and FIG. 12 depict views of still another embodiment of resiliently deformable body 14 comprising multiple flexible pop-out sections 42. Each individual pop-out section 42 may be formed on a respective leg 21 of resiliently deformable body 14. Resiliently deformable body 14 may be formed from plastic or other material suitable for the intended purposes described herein. For example, pop-out section 42 may be formed from resilient rubber while the remaining portions of resiliently deformable body 14 may be a rigid plastic (e.g., formed, for example, via a two shot injection molding process). Other materials may be employed. Pop-out sections 42 may be configured to protrude (e.g., in the shape of a hemispherical shell) with respect to first surface 15 of resiliently deformable body 14 (e.g., shown clearly in FIG. 11). In this manner, second surface 17 may lay flat (FIG. 11) when supported on a surface, such as a table top. Pop-out sections 42 may be substantially flexible as to allow a user to deflect (e.g., “pop out”) the pop-out sections 42 to protrude with respect to second surface 17 of resiliently deformable body 14. For example, in FIG. 12, pop-out sections 42 formed on opposing legs 21 may be deflected to protrude with respect to second surface 17, such that opposing legs 21 may be elevated with respect to second surface 17 and support surface 1100. The shape of resiliently deformable body 14 formed in this manner may be used to cradle and/or position a subject on their back (the shape being similar to FIG. 4, for example). One skilled in the art may clearly envision that other shapes may be formed though manipulation of one or more pop-out sections 42 as described herein.

It is noted that resiliently deformable body 14 in the current embodiment may be employed with a cover, such as cover 31 shown previously in FIG. 1 to form support structure 12 as described herein. In other embodiments however, support structure 12 may solely comprise the current embodiment of resiliently deformable body 14 wherein resiliently deformable body 14 may include an integrally formed padding layer to provide the suitable cushion for the subject without the use of a cover.

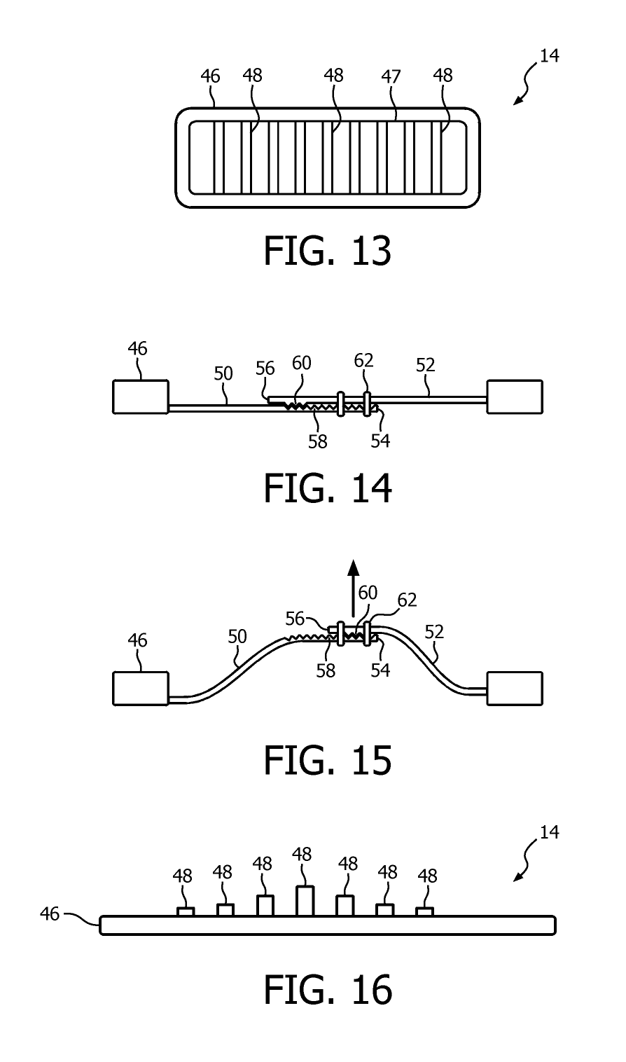

FIG. 13 depicts a top view of still another embodiment of resiliently deformable body 14 comprising frame 46. Frame 46 may be substantially rectangular in shape, and/or may be of a different shape suitable for the intended purpose described herein. Frame 46 may include aperture 47 such that frame 46 essentially comprises the circumferential edge of aperture 47. Resiliently deformable body 14 may include multiple cross members 48. Cross members 48 may span aperture 47 from opposing sides of frame 46 as shown. Individual ones of cross members 48 may be configured to hold a user-configured shape. The current embodiment of resiliently deformable body 14 may be configured for employment particularly in the trunk support region 24 of support structure 12 as shown previously in FIG. 1 to provide subject positioning provisions for the back of the subject (e.g., spinal positioning and/or support). In particular, resiliently deformable body 14 may be configured to hold a shape in which the individual cross members 48 bow outwardly with respect to frame 46. For example, in FIG. 16, multiple cross members 48 may be bowed outwardly to various heights in a manner which may be suitable to provide lumbar support for positioning a subject on their back.

FIG. 14 and FIG. 15 depict detailed views of an individual cross member 48 of resiliently deformable body 14 of FIG. 13 showing an example of a mechanism to facilitate user-configuration of individual cross members 48. In particular, cross member 48 shown may comprise opposing projections 50, 52 extending from frame 46 inwardly into aperture 47. Projections 50, 52 may have distal ends 54, 56 respectively, which overlap a distance as shown. The contact surfaces of projections 50, 52 may have opposing and interlocking teeth 58, 60, respectively. Interlocking teeth 58, 60 may be biased together through the provision of one or more bands 62 which essentially hold projections 50, 52 securely together with some force (e.g., bands 62 may be elastic bands or the like). For user configuration of resiliently deformable body 14 wherein one or more cross members 48 bow outwardly as shown in FIG. 15, the user must overcome the force from bands 62 used to maintain the interlocking position of opposing teeth 58, 60. The user may simply push on cross member 48 from one side to bow cross member 48 outward a distance toward the direction of force. As distal ends 54, 56 come together, cross member 48 will begin bow outwardly. Once at the desired bowed distance, opposing teeth 58, 60 may then re-interlock to hold the position when the user releases their pushing force.

The above description of the interlocking teeth mechanism to facilitate resilient deformability of resiliently deformable body 14 is provided merely as an illustrative example, and should not be considered limiting. Other techniques and/or mechanisms which carry out the intended purpose of this disclosure may be employed and are anticipated.

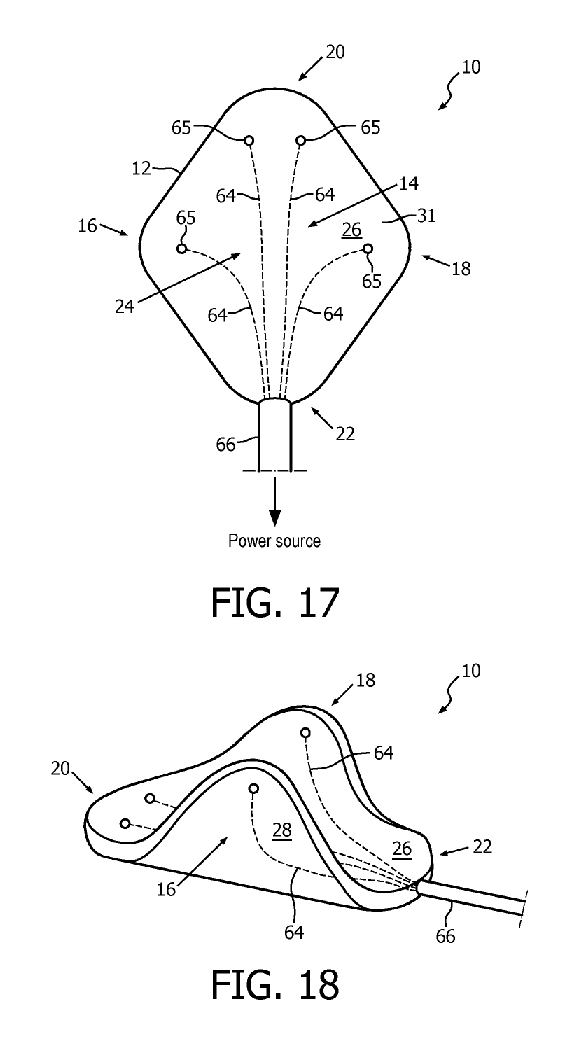

FIG. 17 and FIG. 18 show yet another embodiment of reformable positioning device 10 comprising resiliently deformable body 14 including shape memory wires 64 (e.g., muscle wires or other reactive material) embedded within cover 31 and/or otherwise engaged to support structure 12 (e.g., shown in dashed lines). For example shape memory wires 64 may be engaged on first surface 26, second surface 28, and/or at an intermediate location between first surface 26 and second surface 28 (e.g., an intermediate layer of cover 31).

Shape memory wires 64 may have distal ends 65 secured to various locations on support structure 12. For example one or more shape memory wires 64 may have distal ends 65 engaged at or near right side arm support region 16, left side arm support region 18, head support region 20, and leg support region 22. The proximal ends 66 of shape memory wires 64 may be engaged to and/or otherwise communicate with a power source. In use, controlling the shape of reformable positioning device 10 may be accomplished by selectively running a trigger through shape memory wires 64. For example, a trigger may be an electrical current, UV light, heat, and/or other trigger powered by a power source and/or other source. The presence of a current (or other trigger) in shape memory type allows used for shape memory wires 64 may cause shape memory wires 64 to change shape and hold the shape. For example, absent an amount of current (or other trigger), shape memory wires 64 may be generally flexible such that reformable positioning device 10 lies flat. Application of an amount of current (or other trigger) may cause shape memory wires 64 to stiffen and/or “remember” a shape which causes at least a region of support structure 12 to deform and hold the shape, such as that shown in FIG. 18.

It is noted that the depiction in FIG. 18 is meant to be illustrative and not limiting. In some embodiments, more or less shape memory wires 64 may be engaged to support structure 12 in other locations and/or configurations such that applying a current could allow reformable positioning device 10 to form and hold other shapes.

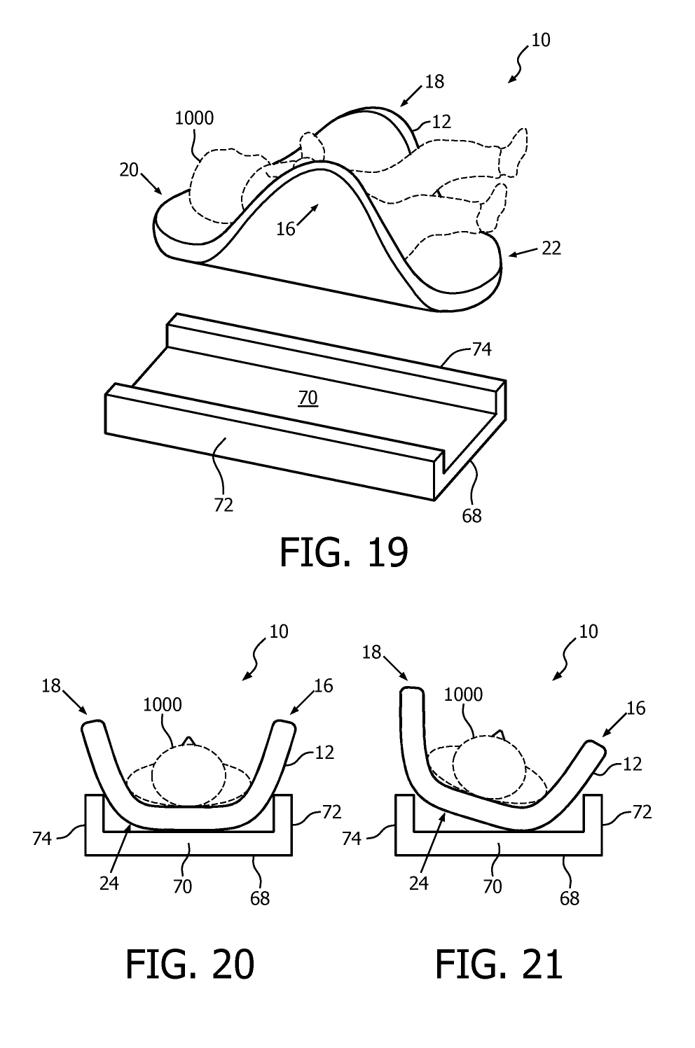

FIG. 19 shows still another embodiment of reformable positioning device 10 comprising support structure 12 and a base component 68. Base component 68 may be employed to position, and reposition, support structure 12 as needed for repositioning a subject (e.g., infant subject 1000) supported by support structure 12. In particular, base component 68 facilitates repositioning support structure 12 without disturbing the shape formed by support structure 12 or the subject supported thereon. Base component 68 may comprise a central portion 70 and sidewalls 72, 74 extending upwardly from the lateral sides of central portion 70. Base component 68 may support support structure 12 and facilitate repositioning of support structure 12 on base component 68 in any number of positions. In particular, base component 68 may be particularly advantageous since repositioning of support structure 12 on base component 68 may be performed without substantially altering and/or disturbing the shape of support structure 12 (e.g., shown in FIG. 20 and FIG. 21).

FIG. 20 shows an end view of the embodiment of reformable positioning device 10 of FIG. 19 showing infant subject 1000 supported on support structure 12, wherein support structure 12 is supported by base component 68 in a first supported position. For example, in the first supported position of support structure 12, trunk support region 24 may be generally supported by central portion 70 and right side arm support region 16 and left side arm support region 18 may be supported by sidewalls 72, 74, respectfully. It is noted that the current depiction of base component 68 is for illustrative purposes and should not be considered limited by the depiction. It is envisioned that base component may have different dimensions and/or configurations than that shown in the current depictions. For example, sidewalls 72, 74 may be taller or shorter, and central portion 70 may be wider or thinner and/or longer or shorter than currently depicted with respect to the size and dimensions of support structure 12. In some embodiments, central portion 70 may have a curved (e.g., convex) surface communicating between the lateral side edges (e.g., between sidewalls 72, 74).

FIG. 21 shows an end view of the embodiment of reformable positioning device 10 of FIG. 19 showing support structure 12 positioned to a second supported position. The second supported position may be a repositioning of support structure 12 shown in FIG. 20 which positions support structure 12 and infant subject 1000 at an angle and/or on one side (e.g., as opposed to flat on their back). In the second supported position, trunk support region 24 may be elevated and supported by sidewall 74 of base component 68 such that infant subject 1000 may be supported substantially more on their right side (e.g., on right side arm support region 16). It is noted that base component 68 is not limited to only supporting support structure 12 in the first and second supported positions shown and may in fact be employed to essentially position support structure 12 in any supported position with the intent of not disturbing and/or substantially altering the shape formed by support structure 12.

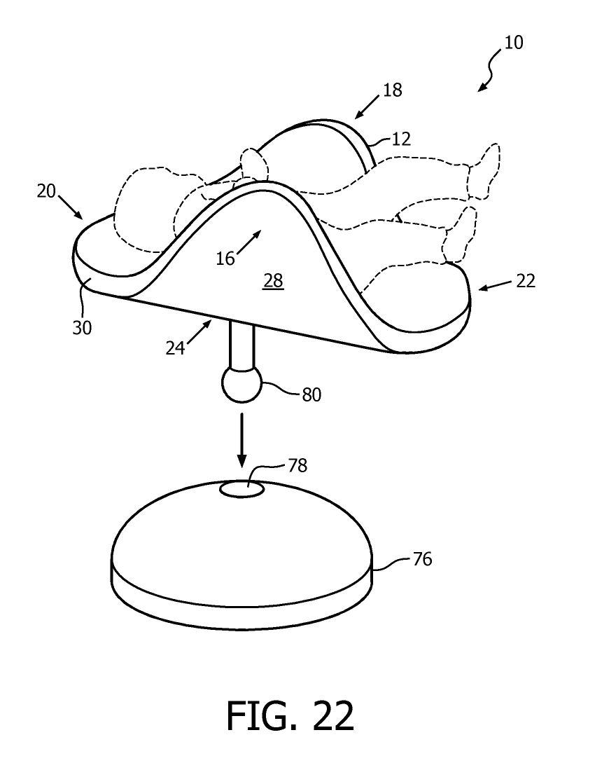

FIG. 22 shows a view of still another embodiment of the reformable positioning device 10 comprising support structure 12 and a base component 76 configured for removable engagement to support structure 12. In some embodiments, base component 76 may be configured to removable engage support structure 12 in a rotatable engagement, such that support structure 12 can rotate with respect to base component 76. This may allow a user to change the orientation and/or positioning of support structure 12 as a whole with respect to base component 76. Again, this embodiment may facilitate repositioning of support structure 12 without substantially altering the shape formed by support structure 12 to support a subject thereon.

In some embodiments, rotatable and removable engagement is provided by a socket 78 included in base component 76. Support structure 12 includes a complimentary ball joint 80. Ball joint 80 may be engaged to, and extend from support structure 12. For example, ball joint 80 may be engaged to second surface 28 of support structure 12. Socket 78 of base component 76 is preferably configured to removably engaged ball joint 80 such that support structure 12 is supported by base component 78. The rotatable engagement of the removable ball-and-socket type joint provided by socket 78 and ball joint 80 facilitates rotation, pitch, and yaw orientation changes to be made to support structure 12 with respect to base component 78. Preferably there is a substantial amount of rotational friction between ball joint 80 and socket 78 such that once rotated to the desired position, ball joint 80 and socket 78 will hold the position (e.g., until acted upon by the user).

The above description of removable and rotatable engagement of support structure 12 to base component 68/76 is for illustrative purposes and not intended to be limiting. Other techniques for rotatable engagement may be employed and are anticipated. In some embodiments, the engagement may be non-removable.

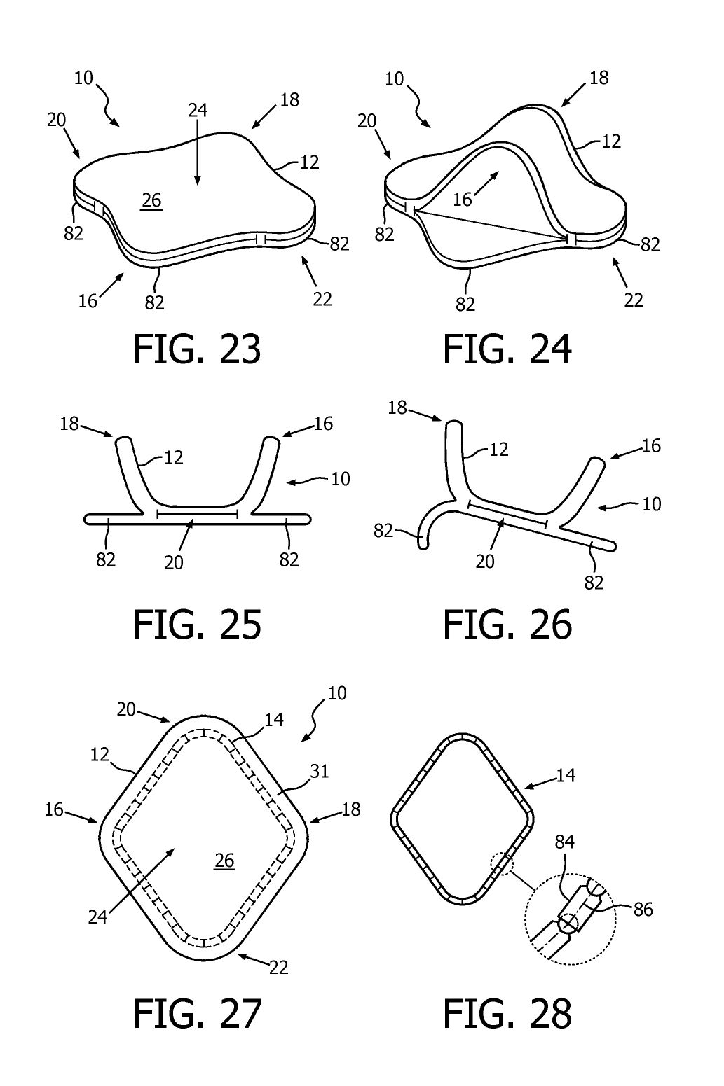

FIG. 23-FIG. 26 show views of still yet another embodiment of reformable positioning device 10 having repositioning components 82 integrated into support structure 12. Repositioning components 82 may be incorporated into support structure 12 at or near one or more of the right side arm support region 16, left side arm support region 18, head support region 20, and/or leg support region 22 as shown. Repositioning components 82 may be employed to reposition and/or change the orientation of support structure 12 without substantially altering the shape formed by support structure 12 (e.g., formed by right side arm support region 16, left side arm support region 18, head support region 20, and leg support region 22), similar to the functionality provided by the base components presented previously. Currently repositioning components 82 comprise flaps and/or similar elements integrated into support structure 12 which are resiliently deformable. For example, repositioning components 82 may individually include some form of resiliently deformable body enclosed and/or comprised therein. As shown, repositioning components 82 may be user configurable separately from right side arm support region 16, left side arm support region 18, head support region 20, and leg support region 22 of support structure 12.

Referring now to the end views shown in FIG. 25 and FIG. 26 (as viewed from head support region 20 toward leg support region 22), repositioning components 82 may be used to support support structure 12 in any number of positions as needed to change the orientation of support structure 12 (e.g., as opposed to simply lying flat as shown in FIG. 25). FIG. 26 shows repositioning component 82 adjacent left side arm support region 18 configured to prop up the left side arm region 18 of support structure 12 as may be a desired position of support structure 12 for supporting a subject. It is noted that the provision of one or more repositioning components 82 may be employed with any of the embodiments of reformable positioning device 10 presented herein.

FIG. 27 and FIG. 28 shows still yet another embodiment of reformable positioning device 10. Support structure 12 includes cover 31 and resiliently deformable body 14 comprising a structure configured to run the periphery of support structure 12 (e.g., and/or substantially near peripheral side edge 30 of support structure 12). As shown in FIG. 28, and in particular in the inset shown in FIG. 28, resiliently deformable body 14 in the current embodiment may be formed from multiple ball-and-socket type links 84 engaged end to end. The peripheral structure formed by resiliently deformable body 14 may include a substantially amount of rotational friction between adjacent links 84, such that resiliently deformable body 14 can be resiliently deformed and retains a desired shape. In some embodiments resiliently deformable body 14 may be provided by other structures suitable for the intended purpose. For example, in some embodiments, resiliently deformable body 14 may comprise a peripheral structure formed from ball chain, flexible hose and/or conduit, or the like.

In one embodiment, resiliently deformable body 14 is formed from ball chain having an internal wire 86 running axially through the ball links which form the chain. Internal wire 86 may be configured to be pulled and/or tightened (e.g., may have a free end which extends out of the ball chain which may be configured to be grasped by a user) to increase the friction between adjacent ball links in order to lock and/or substantially lock the ball chain in a desired shape (e.g., increase the friction between adjacent links due to the force of the tightened internal wire running axially there through).

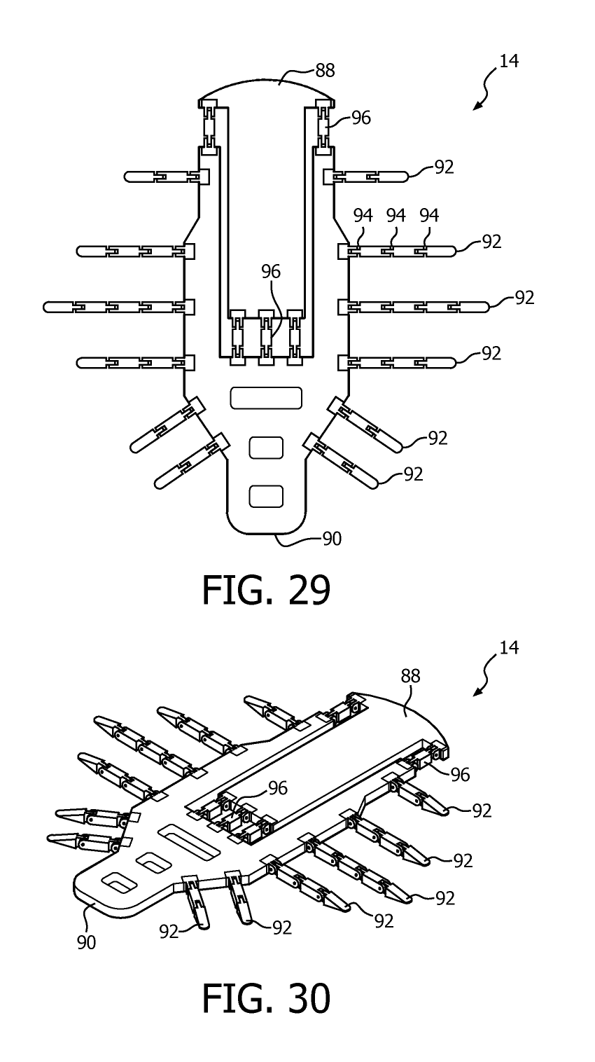

FIG. 29 and FIG. 30 show still yet another embodiment of resiliently deformable body 14. Resiliently deformable body 14 in the current embodiment comprises a first planar section 88 and a second planar section 90. In use with a cover for forming support structure, first planar section 88 may align, register, and/or otherwise correspond with the head support region (and/or trunk support region) of the support structure, while second planar section 90 may align, register, and/or otherwise correspond with the leg support region (and/or trunk support region) of the support structure (e.g., such as support structure 12 shown in FIG. 1). First planar section 88 and second planar section 90 may be configured to rotate and/or otherwise articulate relative to each other through one or more connector hinges 96. Connector hinges 96 effectively rotatably engage first planar second 88 to second planar section 90. Connector hinges 96 may be any hinge or rotatable mechanism suitable for the intended purpose. Connector hinges 96 may include an amount of rotatable friction such that connector hinges 96 will maintain a user-configured position of first planar section 88 rotated with respect to second planar section 90 (e.g., to facilitate resilient deformability of the head support region and leg support region of a support structure formed using the current embodiment of resiliently deformable body 14).

Resiliently deformable body 14 in the present embodiment includes multiple articulable arms 92. Articulable arms 92 may comprise one or more hinges 94 to facilitate increased articulation of articulable arms 92 (e.g., with respect to their engagement to one of first planar section 88 or second planar section 90). Hinges 94 may include an amount of rotatable friction such that hinges 94 will maintain a user-rotated position (e.g., until acted upon again by the user). Articulable arms 92 may be engaged to first planar section 88 and/or second planar section 90 in locations which may align and/or register one or more of the articulable arms 92 with one or more of a head support region, leg support region, right side arm support region, and left side arm support region of a support structure including resiliently deformable body 14 of the present embodiment (e.g., such as support structure 12 shown in FIG. 1). Resiliently deformable body 14 may be formed from any material suitable for the intended purpose such as light weight plastics.

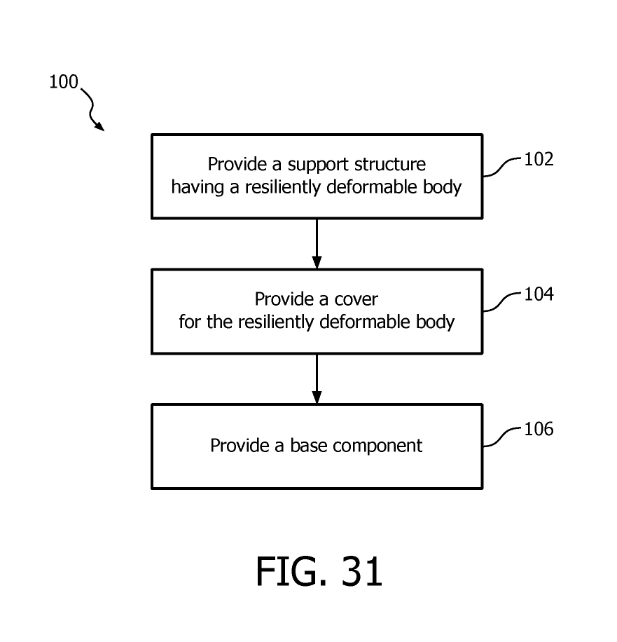

FIG. 31 illustrates a method 100 of providing a reformable positioning device for positioning a subject lying thereon. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 31 and described below is not intended to be limiting.

At an operation 102, a support structure is provided. The support structure may include a resiliently deformable body. In some embodiments, operation 102 is performed with a support structure the same or similar as support structure 12 (shown in FIG. 1-30 and described herein). In some embodiments, operation 102 is performed with a resiliently deformable body the same or similar as resiliently deformable body 14 (shown in FIG. 1-30 and described herein).

At an operation 104, a cover for the resiliently deformable body 14 is provided. In some embodiments, operation 104 is performed with a cover the same or similar as cover 31 (shown in FIG. 1-30 and described herein).

At an operation 106, a base component is provided. In some embodiments operation 106 is performed with a base component the same or similar as base component 68 and/or 76 (shown in FIG. 19-22 and described herein).

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A reformable positioning device for positioning a subject comprising:
a support structure comprising a resiliently deformable body constructed and arranged to be selectively deformably reshaped and to retain its deformed shape upon being deformed by a user, the resiliently deformable body being configured to retain the deformed shape in accordance with a desired configuration that provides desired positioning of the subject, wherein the resiliently deformable body includes multiple user-configurable components for forming the desired shape for positioning the subject, individual ones of the user-configurable components being independently configurable relative to other ones of the user-configurable components; and
wherein the support structure includes support surface having dimensions to accommodate the entire body of the subject, the support surface having multiple support regions individually corresponding to a given user-configurable component.

2. The device of claim 1 wherein the support regions of the support structure comprise a right side arm support region, a left side arm support region, a head support region, a leg support region, and a trunk support region.

3. The device of claim 2 wherein the dimensions of the support surface are defined by a longitudinal length and a lateral length, wherein the longitudinal length is a distance from the head support region of the support structure to the leg support region, wherein the lateral length is a distance from the right side arm support region to the left side arm support region, and wherein the ratio of the longitudinal length to the lateral length is in the range of 1:1 to 2:1 or 1:1 to 1:2.

4. The device of claim 1 wherein the support structure further comprises:
a cover for the resiliently deformable body configured to hold the shape formed by the resiliently deformable body; and
wherein the resiliently deformable body of the support structure comprises wire-formed mesh material.

5. (canceled)

6. The device of claim 1 further comprising a base component for supporting the support structure, wherein the orientation of the support structure is repositionable with respect to the base component.

7. A method of providing a reformable positioning device for positioning a subject comprising:
providing a support structure comprising a resiliently deformable body constructed and arranged to be selectively deformably reshaped and to retain its deformed shape upon being deformed by a user, the resiliently deformable body being configured to retain the deformed shape in accordance with a desired configuration that provides desired positioning of the subject, wherein the resiliently deformable body includes multiple user-configurable components for forming the desired shape for positioning the subject, individual ones of the user-configurable components being independently configurable relative other ones of the user-configurable components; and
wherein the support structure includes support surface having dimensions to accommodate the entire body of the subject, the support surface having multiple support regions individually corresponding to a given user-configurable component.

8. The method of claim 7 wherein the support regions of the support structure comprise a right side arm support region, a left side arm support region, a head support region, a leg support region, and a trunk support region.

9. The method of claim 8 wherein the dimensions of the support surface are defined by a longitudinal length and a lateral length, wherein the longitudinal length is a distance from the head support region of the support structure to the leg support region, wherein the lateral length is a distance from the right side arm support region to the left side arm support region, and wherein the ratio of the longitudinal length to the lateral length is in the range of 1:1 to 2:1 or 1:1 to 1:2.

10. The method of claim 7 wherein the support structure further comprises:
a cover for the resiliently deformable body configured to hold the shape formed by the resiliently deformable body; and
wherein the resiliently deformable body of the support structure comprises wire-formed mesh material.

11. (canceled)

12. The method of claim 7 further comprising the operation of providing a base component for supporting the support structure, wherein the orientation of the support structure is repositionable with respect to the base component.

13. A reformable positioning device for positioning a subject comprising:
supporting means comprising resiliently deformable means constructed and arranged to be selectively deformably reshaped and to retain its deformed shape upon being deformed by a user, the resiliently deformable means being configured to retain the deformed shape in accordance with a desired configuration that provides desired positioning of the subject, wherein the resiliently deformable means includes multiple user-configurable components for forming the desired shape for positioning the subject, individual ones of the user-configurable components being independently configurable relative other ones of the user configurable components; and
wherein the support structure includes supporting surface means having dimensions to accommodate the entire body of the subject, the support surface having multiple support regions individually corresponding to a given user-configurable component.

14. The device of claim 13 wherein the support regions of the supporting means comprise a right side arm support region, a left side arm support region, a head support region, a leg support region, and a trunk support region.

15. The device of claim 14 wherein the dimensions of the supporting surface means are defined by a longitudinal length and a lateral length, wherein the longitudinal length is a distance from the head supporting means of the supporting means to the leg supporting means, wherein the lateral length is a distance from the right side arm supporting means to the left side arm supporting means, and wherein the ratio of the longitudinal length to the lateral length is in the range of 1:1 to 2:1 or 1:1 to 1:2.

16. The device of claim 13 wherein the supporting means further comprises:
covering means for the resiliently deformable means configured to hold the shape formed by the resiliently deformable means; and
wherein the resiliently deformable means of the supporting means comprises wire-formed mesh material.

17. (canceled)

18. The device of claim 13 further comprising a support structure supporting means for supporting the support structure, wherein the orientation of the support structure is repositionable with respect to the support structure supporting means.
